(19) United States
(12) Patent Application Publication
(10) Pub. No.: US 2022/0063097 A1
(43) Pub. Date: Mar. 3, 2022

(54) System for Emulating Remote Control of a Physical Robot

(71) Applicant: Telefonaktiebolaget LM Ericsson (publ), Stockholm (SE)

(72) Inventors: Géza Szabó, Kecskemét (HU); Jozsef Peto, Mezokövesd (HU); Sándor Rácz, Cegléd (HU); Norbert Reider, Tényö (HU)

(21) Appl. No.: 17/421,122

(22) PCT Filed: Jan. 16, 2019
(86) PCT No.: PCT/EP2019/051064

§ 371 Date: Jul. 7, 2021

(51) Int. Cl. B25J 9/16; B25J 13/08; B25J 13/00; B65G 1/137

(52) U.S. Cl. CPC B25J 9/1664; B25J 9/1651; B25J 9/1671; B65G 1/1373; B25J 13/088; B25J 13/006; B25J 9/1653

(57) ABSTRACT

A system (1) for emulating remote control of a physical robot (5) via a wireless network (11) is disclosed. The system comprises a control module (2) for determining a trajectory for the physical robot and generating trajectory control data that comprises velocity data and positional data based on the determined trajectory. The system further comprises a first control loop (3), comprising a first feed forward controller (4). The first feed forward controller is configured to receive the trajectory control data, send, via the wireless network (11), and a first velocity command to a first control interface of the physical robot (5). The first velocity command is based on the trajectory data. The first feed forward controller (4) is further configured to receive, via the wireless network, a first set of sensor data from physical robot. The system (1) further comprises a simulated robot implementing a digital twin (9) of the physical robot, and a second control loop (6) comprising a second feed forward controller (7). The second feed forward controller is configured to receive, via the wireless network, a second set of sensor data from the physical robot, determine a second velocity command based on the received second set of sensor data, and send the second velocity command to a second control interface of the digital twin. A corresponding method (100) is also disclosed.

### TECHNICAL FIELD

The present disclosure generally relates to industrial automation. In particular, the present disclosure relates to a system and method for emulating remote control of a physical robot via a wireless network.

### BACKGROUND

Industrial applications are at the heart of the Internet of Things (IoT) in an Industry 4.0 vision. By enabling the physical execution of industrial processes to be observed, monitored, controlled, and automated in the digital domain, the Industrial IoT can deliver an important leap in productivity and trigger economic growth.

Among the many industrial IoT use cases e.g., cell automation, automated guided vehicles, etc. where wireless communication can play a significant role, this application generally focuses on remote robot control in this paper.

A Cyber Physical Production System (CPPS) is a system where mechatronic components are coupled to a smart logical entity that enables these factory units to interact in an adaptive way. It consist of autonomous and cooperative elements and associated sub-systems that are getting into connection with each other in situation dependent ways, on and across all levels of production, from processes through machines up to production and logistics networks.

Driven by the development of big data analytics, faster algorithms, increased computation power, and the amount of available data enable, it is possible to create simulations with ability of real-time control and optimization of products and production lines. This is referred to as a Digital Twin (DT), using a digital copy of a physical system to perform real-time optimization.

However, conventional Digital Twin solutions are not adapted to the Industry 4.0 vision, and suffer from general drawbacks related to inadequate accuracy, e.g., by not accounting for all the parameters, e.g., network aspects, associated with modern physical production systems.

### SUMMARY

There is a need for an improved technique for analysing an automated physical production system, e.g., a Cyber Physical Production System (CPPS).

It is therefore an object of the present invention to provide a system and a method for emulating remote control of a physical robot via a wireless network, which alleviate all or at least some of the above-discussed drawbacks of presently known systems.

This object is achieved by means of a system and a method for emulating remote control of a physical robot via a wireless network as defined in the appended claims. The term exemplary is in the present context to be understood as serving as an instance, example or illustration.

The present inventors realized that by exchanging the simulated delay and simulated robot with a real network connection and real robot arm forming the Digital Twin of the real hardware in a simulation environment, it is possible to improve the analysis. Moreover, it is possible to reduce costs associated with erroneous installations and configurations of the real physical system(s) due to inaccurate simulations. In more detail, the proposed invention enables the analysis of a real robot and how the real robot control is affected by a real network connection in a simulated complex production environment. The present disclosure illustrates how a digital twin of a real physical robot arm can be deployed into a simulated factory cell where the physical robot is controlled from a cloud computing domain.

An advantage of the proposed solution is that the network effect is taken into consideration during robot cell planning by introducing it into the simulation. In more detail, by introducing two feed forward loops and synchronizing them, the two independent control loops are coupled and an improved digital twin representation of a physical robot can be realized, as compared to prior known solutions.

According to a first aspect, there is provided a system for emulating remote control of a physical robot via a wireless network. The system comprises a control module for determining a trajectory for the physical robot and generating trajectory control data that comprises velocity data and positional data based on the determined trajectory. The system further comprises a first control loop, comprising a first feed forward controller. The first feed forward controller is configured to receive the trajectory control data, send, via the wireless network, and a first velocity command to a first control interface of the physical robot. The first velocity command is based on the trajectory data. The first feed forward controller is further configured to receive, via the wireless network, a first set of sensor data from physical robot. The system further comprises a simulated robot implementing a digital twin of the physical robot, and a second control loop comprising a second feed forward controller. The second feed forward controller is configured to receive, via the wireless network, a second set of sensor data from the physical robot, determine a second velocity command based on the received second set of sensor data, and send the second velocity command to a second control interface of the digital twin.

Hereby, a factory integrator can do the planning and optimization of the factory cell offsite, while an operator can provision the 5G slice in advance: radio, edge cloud, etc. Digital twin refers to a digital replica of a physical asset (physical twin), i.e. a physical robot in the present context. The digital representation provides both the elements and the dynamics of how the physical robot operates and lives throughout its life cycle.

The control module and control loops may be implemented using cloud computing resources. The control module and control loops may thus be realized in a cloud computing domain. The cloud computing domain, in turn, is communicatively coupled to a wireless access domain for wireless command transmission towards a robot cell domain, in which the physical robot is residing.

According to an exemplary embodiment, the second set of sensor data comprises velocity data and positional data, and the positional data is computed based on the velocity data. In other words, the system has an interpolation of position from velocity function. The update frequency of the velocity commands is different for the digital twin and the physical robot which may introduce disturbances in the movements of the digital twin when no status information from the physical robot is received. Thus, by implementing the interpolation of position from velocity function this problem can be mitigated. In other words, this is advantageous in order to make the simulated robot (digital twin) operate smoothly even when no status information is received from the physical robot.

In more detail, since the update frequency of the digital twin and the physical robot are different, the second control module (i.e. the control module of the digital twin) may need to send a command to the robot at that moment when no status information is received. So based on the latest velocity commands one can calculate a function/curve that tells to the control module of the digital twin where the physical robot should be in position at a given time so the second control module can use this to set and send the necessary velocity command accurately. Thus, using the calculated curve it is possible to interpolate/calculate any arbitrary point of the curve.

Further, according to another aspect, there is provided a method for emulating remote control of a physical robot via a wireless network. The method comprises generating trajectory control data comprising velocity data and positional data based on a determined trajectory for the physical robot, sending, via the wireless network, a first velocity command to a first control interface of the physical robot, the first velocity command being based on the trajectory control data, and receiving, via the wireless network, a first set of sensor data from the physical robot. The method further comprises controlling a simulated robot implementing a digital twin of the physical robot, receiving, via the wireless network, a second set of sensor data from the physical robot, determining a second velocity command based on the received second set of sensor data, and sending the second velocity command to a second control interface of the digital twin. With this aspect of the present disclosure, similar advantages and preferred features are present as in the previously discussed first aspect.

According to another aspect, there is provided non-transitory computer-readable storage medium storing one or more programs configured to be executed by one or more processors of a robot control system, the one or more programs comprising instructions for performing the method according to any one of the embodiments discussed herein.

Further embodiments of the invention are defined in the dependent claims. It should be emphasized that the term “comprises/comprising” when used in this specification is taken to specify the presence of stated features, integers, steps, or components. It does not preclude the presence or addition of one or more other features, integers, steps, components, or groups thereof.

These and other features and advantages of the present invention will in the following be further clarified with reference to the embodiments described hereinafter.

### BRIEF DESCRIPTION OF THE DRAWINGS

Further objects, features and advantages of embodiments of the invention will appear from the following detailed description, reference being made to the accompanying drawings, in which:

FIG. 1 is a schematic block diagram representation of a system according to an embodiment of the present invention.

FIG. 2 is schematic block diagram representation of a system according to another embodiment of the present invention.

FIG. 3 is a flow chart representation of a method according to an embodiment of the present invention.

### DETAILED DESCRIPTION

Those skilled in the art will appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

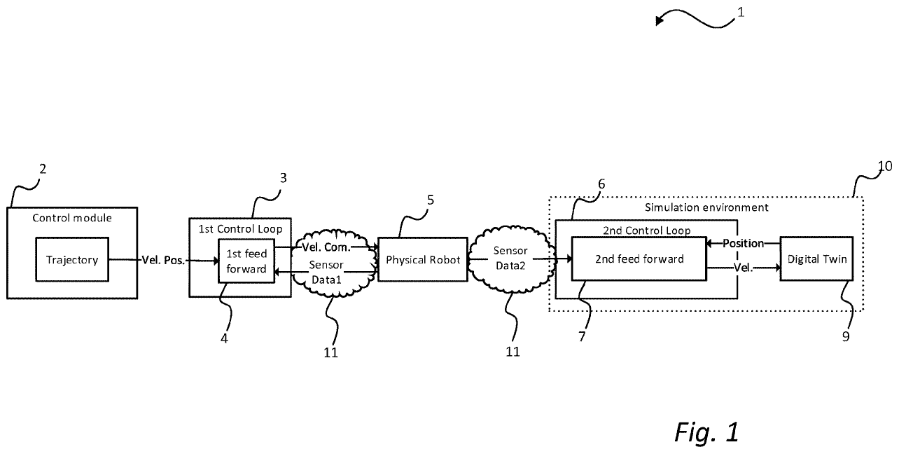

FIG. 1 illustrates a schematic block diagram representation of a system 1 for emulating remote control of a physical robot 5 via a wireless network 11. The system 1 has a control module 2 for determining a trajectory for the physical robot 5 and generating trajectory control data. The trajectory control data comprises velocity data and/or positional data, which are based on the determined trajectory, as indicated by the arrow originating from the control module 2.

Further, the system comprises a first control loop 3 having a first feed forward controller 4 configured to receive the trajectory control data (i.e. the velocity and the position commands from the control module 2). The first feed forward controller 4 is configured to send, via the wireless network 11, a first velocity command to a first control interface of the physical robot 5. The first velocity command is based on the trajectory data. Moreover, the first feed forward controller 4 is further configured to receive, via the wireless network 11, a first set of sensor data (e.g. torque, position, etc.) from the physical robot 5.

The physical robot 5 may comprise a robot arm. The action and, thus, the velocity command may relate to a movement of the robot arm. As such, the command may result in a specific movement action of the robot arm. The robot arm may comprise multiple independently actuatable joints. In such a case, the command may comprise two or more sub-commands for actuation of different ones of the actuatable joints.

The system 1 further comprises a digital twin 9 of the physical robot 5. In the simulation environment 10, the system 1 further has a second control loop 6 comprising a second feed forward controller 7, which is configured to receive, via the wireless network 11, a second set of sensor data form the physical robot. The first set of sensor data and the second set of sensor data may be identical or different depending on specific implementations, and input specifications for the two separate control loops 4, 6. Furthermore, the second feed forward controller 7 is configured to determine a second velocity command based on the received second set of sensor data, and to send the velocity command to a second control interface of the digital twin 9.

The first and second control interfaces are different (different update frequencies), wherefore independent and synchronized control loops for each interface are provided. In more detail, the physical robot 5 (i.e. real robot) and the digital twin (i.e. simulated robot) require different velocity commands and send back different status commands. Thus, a common feed forward controller would only be able to control either the physical robot 5 or the digital twin 9. There are multiple reasons as to why the real and the simulated robot require different control loops 4, 6, but one issue is that the physical robot 5 and the digital twin 9, as mentioned, have different control interfaces (operate at different frequencies). Another issue is that if a common control loop is used it is not ensured that the status is exchanged between the physical robot 5 and the digital twin 9 wherefore wireless network 11 effects (e.g. latency) will not be included in the simulation.

Each control loop 3, 6 may belong to a PID-based control strategy, wherein also a subset of PID control parameters (e.g., only P and I, only D, etc.) can be implemented according to the present disclosure. As such, the control parameter can comprise only on or more of a P parameter, an I parameter and a D parameter. Alternatively, or in addition, the control parameter may comprise a parameter defining a control tolerance setting, as will be further elaborated upon in the detailed description.

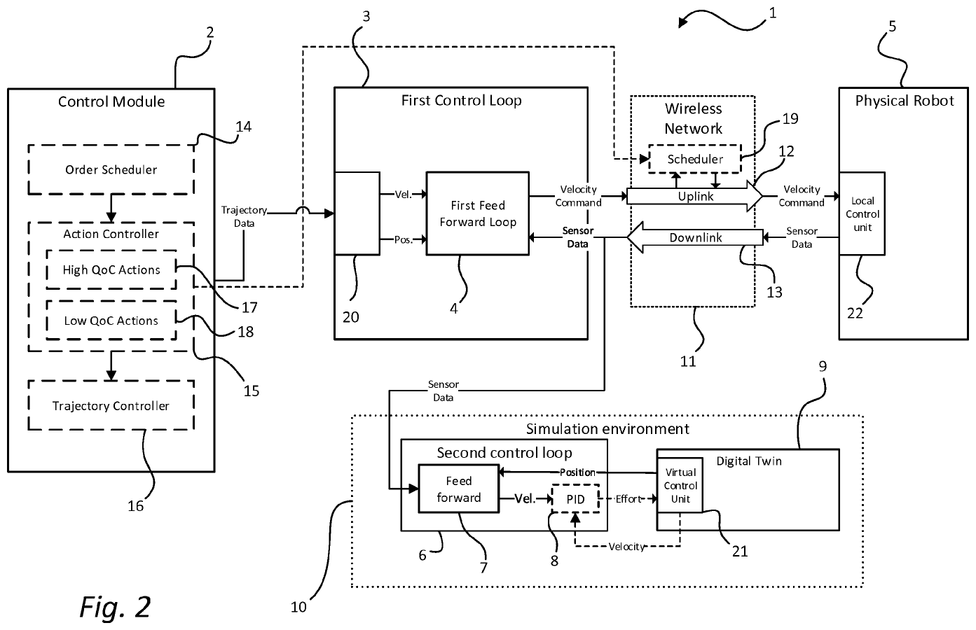

Moreover, in an exemplary embodiment, the same principles may be utilized to realize a physical twin implementation (not shown) by merely switching the position of the physical robot and the digital twin. In more detail, in such an embodiment, the digital twin is connected to the first control loop and the velocity control is applied to the digital twin based on the calculated trajectory control data. The connection between the digital twin and the physical robot is then realized by sending a status (position and velocity data) from the simulation that is received by the second control loop and sent to the physical robot. Thus, in this setup the physical robot copies the movement of the simulated robot. FIG. 2 illustrates a schematic block diagram representation of a system 1 for emulating remote control of a physical robot 5 via a wireless network 11 according to another embodiment of the present invention. The system 1 comprises a control module 2 configured to determine a trajectory for the physical robot and generate trajectory control data comprising velocity data and positional data based on the determined trajectory. The control module 2 is here arranged in a modular configuration with three sub-modules. However, some or all of the functions described in the following may be integrated within the same sub-component/-module. The control module also comprises one or more processing devices (processors) and one or more memory accessible by the processing device(s) as known in the art.

In more detail, the control module 2 comprises a first module 14 configured to receive a status of the working environment and generate an order for execution by the physical robot 5. In other words, the first module (may be referred to as an Order Scheduler), is configured to orchestrate the execution of orders and its kits. The control module 2 also has a second module 15 (may be referred to as an Action Controller) configured to receive the order for execution and to generate an action to be performed by the physical robot 5. Stated differently, the action controller provides a set of abstract robot actions (e.g. move tooltip up, go next to Automated Guide Vehicle (AGV)) and access to gripper control (activate and deactivate).

Further, the control module 2 has a third module 16 arranged to receive the action command and to generate the trajectory data for the physical robot 5. In other words, the third module 16 receives the desired position for the physical robot and computes the set of joint values to achieve the desired configuration. The third module 16 may be in the form of an inverse kinematics component that is in charge of performing an inverse kinematics-based control of the physical robot 5 and the digital twin 9. This control may at least partially be based on sensor data gathered by one or more of the sensors that monitor the movement and states of the physical robot 5 in the robot cell.

The second module 15 is further configured to determine a Quality of Control (QoC) level associated with the received order. Then, based on the determined QoC level, the second module 15 is configured to trigger a setting of queue length for the wireless transmission of the first velocity command via the wireless network. Thus, the second module 15 has a Quality of Control-aware (QoCa) interface, which can setup scheduler queues “on-the-fly”, as indicated by the dashed line to the network scheduler 19. In more detail, the second module may comprise an interface 17 for high QoC level commands, such as e.g. go to initial position, go to belt start, etc., and an interface 18 for low QoC level commands, such as e.g. go down until object is reached, turn wrist, etc.

In more detail, actions associated with low QoC do not significantly influence the final performance of the physical robot 5 (i.e. robot cell). Their execution speed (in terms of movement velocity) is important, so they should be fast, but they need not be accurate and can tolerate a certain overshooting upon execution. In this regard, the following arm control commands and associated actions can be mentioned:
go to initial position: move the arm to its initial position
go to tray position: move the arm to a static position in front of a tray
go to belt start: move to the arm to a static position in front of a start of a belt
go to belt: move the arm to a static position in front of a belt
go to part bin front: move the arm in front of a desired part
go to bin front: move the arm in front of a desired bin
move side ways: move arm along side the belt

There are other actions and associated arm movements requiring high QoC. These actions have a high impact on the final performance of the physical robot 5 as a whole and have to be precise. In this regard, the following arm control commands and associated actions can be mentioned:
go to position a bit above part: move the arm to a position a little bit above a part
go down until get piece: the arm approaches the part to be picked until it is reached
turn wrist: turn the wrist joint of the robot arm, required for example to turn the part upside down
move tool tip: movement of tool center point (TCP) in Cartesian space
move tool tip ZY: movement of TCP in Cartesian space keeping one dimension fixed

The control module 2, control loops 2, 6 and digital twin 9 can be considered to reside in a cloud computing domain, while the network 11 and any Quality of Service interface 19 can be considered to reside in a wireless access domain. The wireless access domain may be a cellular or non-cellular network, such as a cellular network specified by 3GPP. In some implementations, the wireless access domain may be compliant with the 3GPP standards according to Release R15, such as TS 23.503 V15.1.0 (2018-3) or later. The wireless access domain may comprise a base station or a wireless access point (not shown) that enables a wireless communication between components of the physical robot 5 on the one hand and the cloud computing domain on the other via the wireless access domain.

As becomes apparent from the above description, the above discussed exemplary embodiment suggests a switching between transmission channels providing different levels of QoS depending on the different QoC requirements associated with different commands. In this way, differentiated data services may be provided to support varying QoC requirements. Thus, the technique presented herein permits to more efficiently use wireless transmission resources by intentionally relaxing transmission parameter settings for robot control actions that are less sensitive to delays. By properly selecting the control actions for which the transmission parameter setting can relaxed, the overall performance of the robot cell 101 will not be negatively affected. As such, the same level of overall robot cell performance can be realized at a lower utilization of wireless resources.

The physical robot 5 may be referred to as a robot cell and to reside in a robot cell domain. The robot cell domain preferably comprises multiple sensors (not shown) such as cameras, position sensors, orientation sensors, angle sensors, and so on. The sensors generate sensor data indicative of a state of the robot cell 101 (i.e., cell state data). The sensors can be freely distributed in the robot cell. One or more of the sensors can also be integrated into one or more of the physical robots 5.

Moreover, the control module 2, the first control loop 3, and the second control loop 6 can be considered to form a robot cell controller comprising cloud computing resources. The robot cell controller is preferably configured to receive the sensor data (i.e., cell state data) from the sensors (not shown) via the wireless access domain. The robot cell controller is further configured to generate control commands for the physical robot 5 and its digital twin 9, optionally on the basis of the sensor data, and to forward the control commands via the wireless access domain to the robot controllers 21, 22 of the physical robot 5 and the digital twin 9. The robot controllers 21, 22 are configured to wirelessly receive the control commands and to control one or more individual actuators of the physical robot 5 and digital twin 9.

The system 1 has a first control loop 3 with a first feed forward loop 4, and is configured to generate commands corresponding to the actions formed in the control module 2, and send the generated commands via the wireless access domain 11 towards the physical robot 5. For example, the trajectory data or action could be a robot arm movement along a trajectory from A to B, which movement is translated by the first control loop 3 into one or more control commands, in the form of velocity commands, for locally controlling one or more robot arm joint actuators to execute the trajectory from A to B. The system 1 further has a second control loop 6 configured to generate analogous commands for the digital twin 9.

The first control loop 3 and the second control loop 6 may each comprise a PID controller 8, i.e. maintain one or more PID loops, for controlling the execution of orders. Thus, the control loops 2, 6 are configured to control the physical robot 5 and the digital twin 9, respectively, with a PID-based control strategy. The status between the physical robot 5 and the digital twin 9 is exchange by means of a second set of sensor data provided by a local control unit 22 of the physical robot 5 via the wireless network 11, wherefore real network latency is accounted for in the simulation environment 10. The feed forward loops use both position and velocity as input to generate a velocity command. Therefore, if the sensors of the physical robot only provide velocity data, the system may further include another module (not shown) configured to interpolate a position from the velocity data such that the received second set of sensor data comprises velocity data and positional data.

The disclosed system 1 illustrates a means for emulating a digital twin 9 of a physical robot 5, which is controlled from a cloud computing domain. In more detail, the robot and the digital twin are controlled by using velocity control instead of position control. An advantage of implementing velocity control is that the velocity commands are more dynamic (it is possible to rapidly adjust trajectories in case of unforeseen obstacles or problems). In addition, position control is a high level command, and has to be translated to a velocity command locally by the physical robot controller 22. Thus by using velocity commands originating from a cloud computing domain, the need for the conventional ungainly cabinets at the site of the physical robot is alleviated, which can provide a better utilization of space in factories having robot cells. The technique presented herein may be implemented using a variety of robot programming tools and languages. For example, the robot programming language may be based on C++.

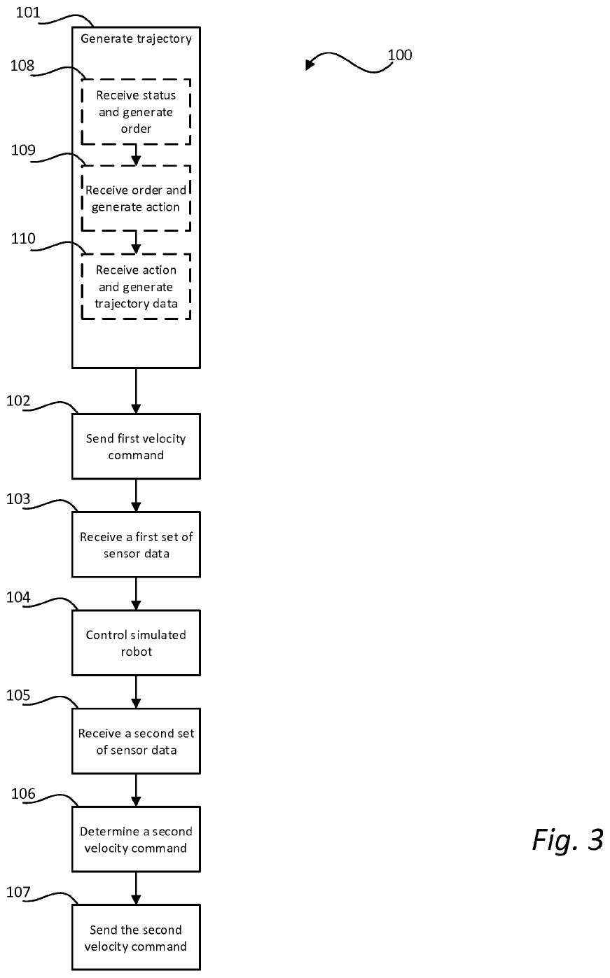

FIG. 3 illustrates a flow-chart representation of a method 100 for emulating remote control of a physical robot via a wireless network. The method comprises generating 101 trajectory control data comprising velocity data and positional data based on a determined trajectory for the physical robot. In more detail, the step of generating 101 trajectory data may include a step of receiving 108 a status of the working environment and generating an order for execution by the physical robot. Further, the order is received 109 and an action is generated 109 to be performed by the physical robot. Next, the action is received 110 and the trajectory data is generated 110 in a subsequent step. The action may be obtained within the cloud computing domain from an order or an action plan associated with the physical robot. Alternatively, or in addition, the action may be obtained based on an evaluation of sensor data received from sensors associated with the physical robot (i.e. inverse kinematics solution.

The action that is obtained in step 110 may be associated with a specific movement that needs to be performed by the physical robot. Depending on the nature of the physical robot, this movement may for example be a movement of a robotic arm or a gripper of the robotic arm.

A physical robot may comprise multiple joints that define individual degrees of freedom for robot arm movement. As understood herein, a control command (velocity command) may pertain to the robot arm as a whole (and may thus comprise multiple sub-commands for the individual joint actuators), or it may pertain to an individual joint actuator of a multi-joint physical robot. A velocity command pertaining to a robot movement may thus result in an action corresponding to a particular robot movement.

Further, the method 100 comprises sending 102, via the wireless network (wireless access domain), a first velocity command to a first control interface of the physical robot. The first velocity command is based on the trajectory control data. A first set of sensor data is received 103, via the wireless network, from the physical robot.

Still further, the method comprises controlling 104 a simulated robot implementing a digital twin of the physical robot. A digital twin may be understood as a “living” digital simulation model that updates and changes as its physical counterpart (physical robot) changes. A digital twin preferably continuously learns and updates itself from multiple sources to represent its near real-time status, working condition or position. Thus, the method comprises receiving 105, via the wireless network, a second set of sensor data from the physical robot.

Next, a second velocity command is determined 106 based on the received second set of sensor data, and sent 107 to a second control interface of the digital twin. The first and second control interfaces (i.e. the control interfaces of the physical robot and digital twin) are different.

The present disclosure has been presented above with reference to specific embodiments. However, other embodiments than the above described are possible and within the scope of the disclosure. Different method steps than those described above, performing the method by hardware or software, may be provided within the scope of the disclosure. Thus, according to an exemplary embodiment, there is provided a non-transitory computer-readable storage medium storing one or more programs configured to be executed by one or more processors of system for emulating remote control of a physical robot via a wireless network, the one or more programs comprising instructions for performing the method according to any one of the above-discussed embodiments. Alternatively, according to another exemplary embodiment a cloud computing system can be configured to perform any of the method aspects presented herein. The cloud computing system may comprise distributed cloud computing resources that jointly perform the method aspects presented herein under control of one or more computer program products.

The processor(s) (associated with the robot control system 1) may be or include any number of hardware components for conducting data or signal processing or for executing computer code stored in memory. The system may have an associated memory, and the memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

The different features and steps of the embodiments may be combined in other combinations than those described.

1-10. (canceled)

11. A system for emulating remote control of a physical robot via a wireless network, the system comprising:
a control module for determining a trajectory for the physical robot and generating trajectory control data comprising velocity data and positional data based on the determined trajectory;
a first control loop, comprising a first feed forward controller configured to:
receive the trajectory control data;
send, via the wireless network, a first velocity command to a first control interface of the physical robot, the first velocity command being based on the trajectory data;
receive, via the wireless network, a first set of sensor data from physical robot;
a simulated robot implementing a digital twin of the physical robot; and
a second control loop, comprising a second feed forward controller configured to:
receive, via the wireless network, a second set of sensor data from the physical robot;
determine a second velocity command based on the received second set of sensor data;
send the second velocity command to a second control interface of the digital twin.

12. The system of claim 11:
wherein the second set of sensor data comprises velocity data and positional data; and
wherein the positional data is computed based on the velocity data.

13. The system of claim 11, wherein the control module comprises:
a first module configured to receive a status of the working environment and generate an order for execution by the physical robot;
a second module configured to receive the order for execution and generate an action to be performed by the physical robot; and
a third module configured to receive the action and to generate the trajectory data for the physical robot.

14. The system of claim 13, wherein the second module is further configured to:
determine a Quality of Control (QoC) level associated with the received order; and
trigger a setting of queue length for the wireless transmission of the first velocity command via the wireless network, wherein the queue length is dependent on the determined QoC level.

15. The system of claim 11, wherein the first control interface is different from the second control interface.

16. A method for emulating remote control of a physical robot via a wireless network, the method comprising:
generating trajectory control data comprising velocity data and positional data based on a determined trajectory for the physical robot;
sending, via the wireless network, a first velocity command to a first control interface of the physical robot, the first velocity command being based on the trajectory control data;
receiving, via the wireless network, a first set of sensor data from the physical robot;
controlling a simulated robot implementing a digital twin of the physical robot;
receiving, via the wireless network, a second set of sensor data from the physical robot;
determining a second velocity command based on the received second set of sensor data; and
sending the second velocity command to a second control interface of the digital twin.

17. The method of claim 16:
wherein the second set of sensor data comprises velocity data and positional data; and
wherein the positional data is computed based on the velocity data.

18. The method of claim 16, wherein the generating trajectory data comprises:
receiving a status of the working environment and generating an order for execution by the physical robot;
receiving the order and generating an action to be performed by the physical robot; and
receiving the action and generating the trajectory data for the physical robot.

19. The method of claim 18, wherein the receiving the order comprises:
determining a Quality of Control (QoC) level associated with the received order; and
triggering a setting of queue length for the wireless transmission of the first velocity command via the wireless network, wherein the queue length is dependent on the determined QoC level.

20. A non-transitory computer-readable storage medium storing a computer program product for emulating remote control of a physical robot via a wireless network, the computer program product comprising program instructions which, when run on processing circuitry of a robot control system, causes the robot control system to:
generate trajectory control data comprising velocity data and positional data based on a determined trajectory for the physical robot;
send, via the wireless network, a first velocity command to a first control interface of the physical robot, the first velocity command being based on the trajectory control data;
receive, via the wireless network, a first set of sensor data from the physical robot;
control a simulated robot implementing a digital twin of the physical robot;
receive, via the wireless network, a second set of sensor data from the physical robot;
determine a second velocity command based on the received second set of sensor data; and
send the second velocity command to a second control interface of the digital twin.
